(19) United States
(12) Patent Application Publication
(10) Pub. No.: US 2016/0288474 A1
(43) Pub. Date: Oct. 6, 2016

(54) BONDING STATE DETECTION METHOD

(71) Applicant: Primax Electronics Ltd., Neihu (TW)

(72) Inventors: YING-CHE TSENG, Neihu (TW); TUNG-HENG WU, Neihu (TW)

(21) Appl. No.: 14/946,387

(22) Filed: Nov. 19, 2015

(30) Foreign Application Priority Data
Apr. 2, 2015 (TW) 104110932

(51) Int. Cl. B32B 37/12; B32B 37/14

(52) U.S. Cl. CPC B32B 37/12; B32B 37/14

(57) ABSTRACT

A bonding state detection method is provided for detecting a bonding state of two substrates. Firstly, a first adhesive element, a second adhesive element, a first substrate and a second substrate are provided. The first adhesive element includes a sensing layer with a first sensing unit and a second sensing unit. After the first substrate and the second substrate are bonded together through the first adhesive element and the second adhesive element, a first resistance value of the first sensing unit and a second resistance value of the second sensing unit are detected. Then, according to the result of comparing the first resistance value with the second resistance value, the bonding state of the first adhesive element and the second adhesive element is judged. Consequently, the bonding state of the first substrate and the second substrate is realized.

### FIELD OF THE INVENTION

The present invention relates to a bonding state detection method, and more particularly to a bonding state detection method for detecting a bonding state of two substrates of an electronic device.

### BACKGROUND OF THE INVENTION

In the fabricating process of a flexible flat cable, a film on glass (FOG) assembly or other electronic products, various adhesives such as anisotropic conductive films (ACF) are widely used to bond substrates together. If the substrates are not completely bonded together, the quality of the electronic product is impaired or even the electronic product is not normally operated. Under this circumstance, the product yield is reduced.

Generally, in the fabricating process of the electronic product, after the substrate and the adhesive are bonded together, a bonding state detection method is performed to detect the bonding state of the substrate and the adhesive.

For example, Taiwanese Patent Publication No. TW201100782 discloses a bonding state detection method for an anisotropic conductive film. In accordance with this bonding state detection method, an illuminating operation and an image pickup operation are performed on an anisotropic conductive film, which is attached on a predetermined location of a lateral side of the substrate. Moreover, the bonding state of the anisotropic conductive film is detected by the result of the image pickup operation.

Moreover, US Patent Publication No. 20080245463 discloses a bonding state detection method for an adhesive. After the capacitance value of the substrate coated with the adhesive is detected, the bonding state of the adhesive on the substrate can be realized by judging whether the capacitance values of plural locations of the substrate comply with the criteria.

However, the above methods can be only used to detect the bonding state of the adhesive and the substrate. That is, the above methods cannot be used to detect the bonding state of two substrates. Even if the adhesive and the substrate are accurately bonded together, the above methods cannot assure whether the two substrates can be accurately bonded together or not.

Therefore, there is a need of providing a bonding state detection method for detecting a bonding state of two substrates in order to overcome the above drawbacks.

### SUMMARY OF THE INVENTION

An object of the present invention provides a bonding state detection method for detecting a bonding state of two substrates.

In accordance with an aspect of the present invention, there is provided a bonding state detection method. Firstly, a first adhesive element, a second adhesive element, a first substrate and a second substrate are provided. The first adhesive element includes a first conductive particle layer and a sensing layer. The sensing layer includes a first sensing unit and a second sensing unit. The second adhesive element includes a second conductive particle layer. The first substrate and the second substrate are bonded together through the first adhesive element and the second adhesive element. The first adhesive element and the second adhesive element are arranged between the first substrate and the second substrate. The first conductive particle layer is adhesively fixed on the sensing layer. The second conductive particle layer is adhesively fixed over the first conductive particle layer. Then, a first resistance value of the first sensing unit and a second resistance value of the second sensing unit are detected. Then, the first resistance value and the second resistance value are compared with each other. If the first resistance value and the second resistance value are different, the first adhesive element and the second adhesive element are not completely adhered by each other.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a flowchart illustrating a bonding state detection method according to an embodiment of the present invention;

FIG. 2 is a schematic cross-sectional view illustrating an assembled structure of a first adhesive element, a second adhesive element, a first substrate and a second substrate using the bonding state detection method according to the embodiment of the present invention;

FIG. 3 schematically illustrates the structure of a sensing layer applied to the bonding state detection method according to the embodiment of the present invention;

FIG. 4 schematically illustrates a variant example of the sensing layer applied to the bonding state detection method according to the embodiment of the present invention; and

FIG. 5 schematically illustrates another variant example of the sensing layer applied to the bonding state detection method according to the embodiment of the present invention.

### DETAILED DESCRIPTION OF THE PREFERRED EMBODIMENT

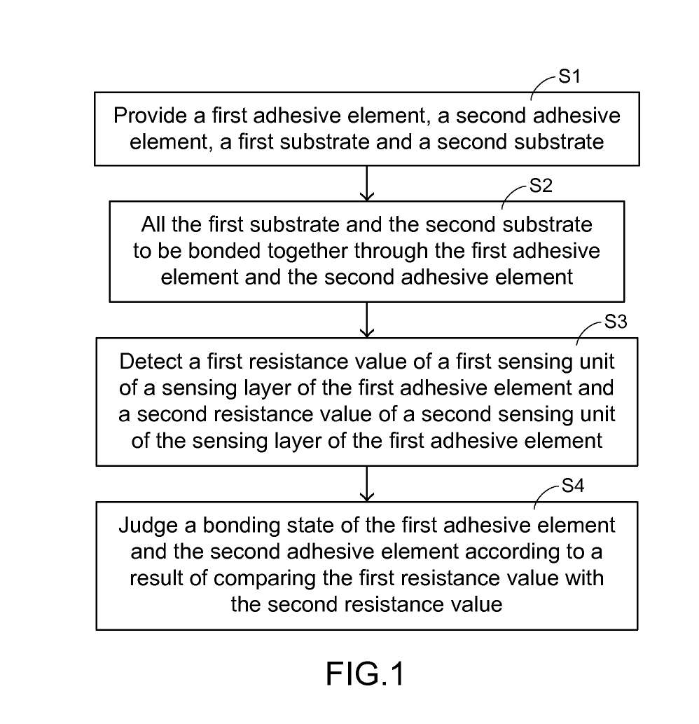

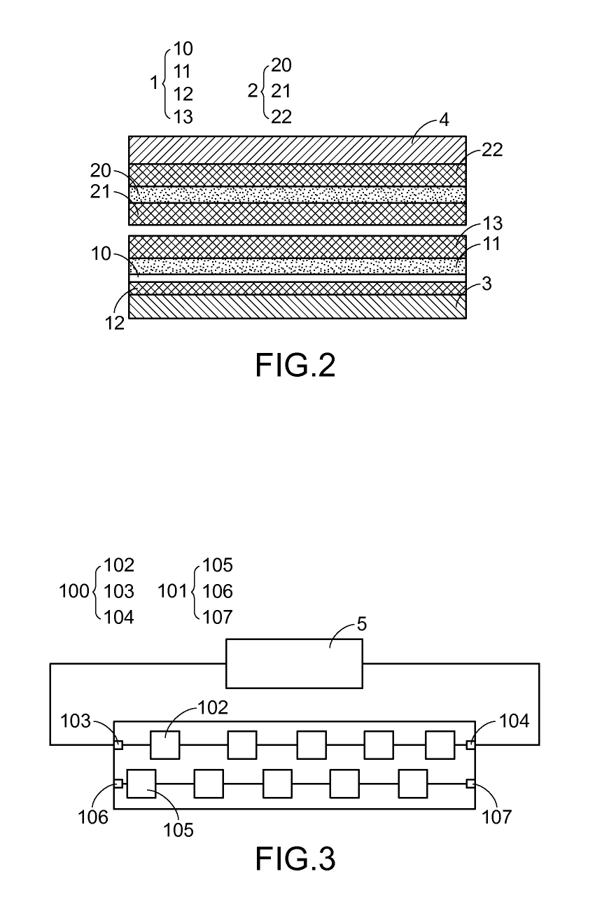

The present invention provides a bonding state detection method for detecting a bonding state of two substrates. Please refer to FIGS. 1, 2 and 3. FIG. 1 is a flowchart illustrating a bonding state detection method according to an embodiment of the present invention. FIG. 2 is a schematic cross-sectional view illustrating an assembled structure of a first adhesive element, a second adhesive element, a first substrate and a second substrate using the bonding state detection method according to the embodiment of the present invention. FIG. 3 schematically illustrates the structure of a sensing layer applied to the bonding state detection method according to the embodiment of the present invention.

The bonding state detection method comprises steps S1, S2, S3 and S4. In the step S1, a first adhesive element 1, a second adhesive element 2, a first substrate 3 and a second substrate 4 are provided. In the step S2, the first substrate 3 and the second substrate 4 are bonded together through the first adhesive element 1 and the second adhesive element 2. In the step S3, a first resistance value of a first sensing unit 100 of a sensing layer 10 of the first adhesive element 1 and a second resistance value of a second sensing unit 101 of the sensing layer 10 of the first adhesive element 1 are detected. In the step S4, a bonding state of the first adhesive element 1 and the second adhesive element 2 is judged according to a result of comparing the first resistance value with the second resistance value.

Firstly, in the step S1 and the step S2, the first adhesive element 1 and the second adhesive element 2 are provided, and the first substrate 3 and the second substrate 4 are bonded together through the first adhesive element 1 and the second adhesive element 2. In particular, the first substrate 3 is adhered by the first adhesive element 1, and the second substrate 4 is adhered by the second adhesive element 2. When the first adhesive element 1 and the second adhesive element 2 are adhered by each other, the first substrate 3 and the second substrate 4 are bonded together.

The structures of the first adhesive element 1 and the second adhesive element 2 will be described as follows. The first adhesive element 1 comprises a sensing layer 10, a first conductive particle layer 11, a first adhesive layer 12 and a second adhesive layer 13. The second adhesive element 2 comprises a second conductive particle layer 20, a third adhesive layer 21 and a fourth adhesive layer 22. The first conductive particle layer 11 and the second conductive particle layer 20 contain conductive particles. Examples of the conductive particles include but are not limited to graphite powdery particles or metallic powdery particles.

The second adhesive layer 13 is located over the first adhesive layer 12. The sensing layer 10 and the first conductive particle layer 11 are arranged between the first adhesive layer 12 and the second adhesive layer 13. Moreover, the sensing layer 10 is adhered by the first adhesive layer 12. The first conductive particle layer 11 is uniformly distributed and adhesively fixed on the sensing layer 10. The first substrate 3 is adhered by the first adhesive layer 12. Moreover, the second adhesive element 2 and the second adhesive layer 13 are adhered by each other.

The fourth adhesive layer 22 is located over the third adhesive layer 21. The second conductive particle layer 20 is uniformly distributed and adhesively fixed between the third adhesive layer 21 and the fourth adhesive layer 22. The third adhesive layer 21 and the second adhesive layer 13 are adhered by each other. The second substrate 4 is adhered by the fourth adhesive layer 22. When the third adhesive layer 21 and the second adhesive layer 13 are completely adhered by each other, the second conductive particle layer 20 is uniformly distributed and adhesively fixed over the first conductive particle layer 11.

Please refer to FIG. 3. The sensing layer 10 is a metal sheet that is adhered by the first adhesive layer 12. After a stamping process or any other appropriate machining process, the first sensing unit 100 and the second sensing unit 101 of the sensing layer 10 are formed. In this embodiment, the first sensing unit 100 of the sensing layer 10 is arranged in a row, and the second sensing unit 101 of the sensing layer 10 is arranged in a row. The first sensing unit 100 comprises plural first conduction structures 102, which are electrically connected with each other. The two first conduction structures 102 at the locations near the two opposite sides of the first adhesive element 1 are electrically connected with a first sensing contact 103 and a second sensing contact 104, respectively. Moreover, the first sensing contact 103 and the second sensing contact 104 are exposed to the two opposite sides of the first adhesive element 1, respectively. The second sensing unit 101 comprises plural second conduction structures 105, which are electrically connected with each other. The two second conduction structures 105 at the locations near the two opposite sides of the first adhesive element 1 are electrically connected with a third sensing contact 106 and a fourth sensing contact 107, respectively. Moreover, the third sensing contact 106 and the fourth sensing contact 107 are exposed to the two opposite sides of the first adhesive element 1, respectively.

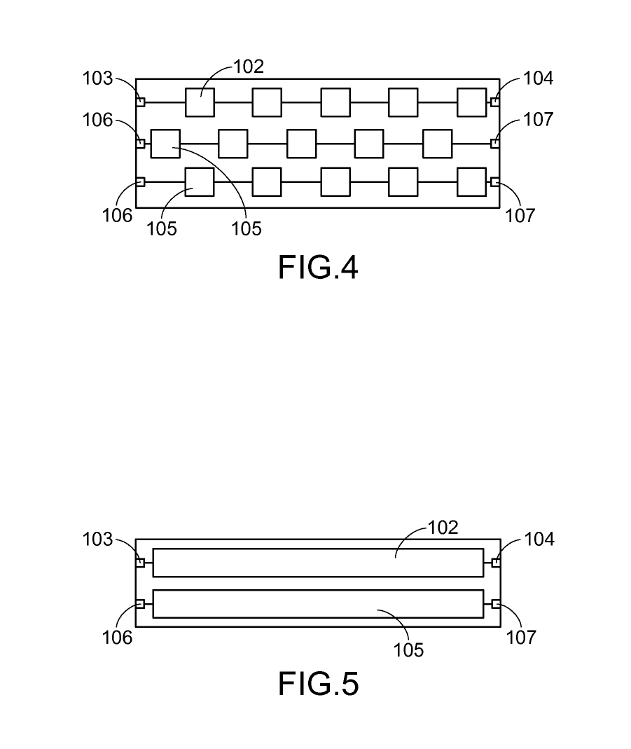

It is noted that the coverage regions of the first sensing unit 100 and the second sensing unit 101 of the sensing layer 10, the row number of the second sensing unit 101, the number of the first conduction structures 102 of the first sensing unit 100 and the number of the second conduction structures 105 of the second sensing unit 101 may be varied according to the practical requirements. FIG. 4 schematically illustrates a variant example of the sensing layer applied to the bonding state detection method according to the embodiment of the present invention. FIG. 5 schematically illustrates another variant example of the sensing layer applied to the bonding state detection method according to the embodiment of the present invention. As shown in FIG. 4, the sensing layer 10 comprises one row of first sensing unit 100 and plural rows of second sensing units 101. As shown in FIG. 5, the first sensing unit 100 comprises a single first conduction structure 102, and the second sensing unit 101 comprises a single second conduction structure 105. As long as the first sensing unit 100 and the second sensing unit 101 are in parallel with each other and the coverage range of each of the first sensing unit 100 and the second sensing unit 101 is approximately equal to the size of the first adhesive layer 12, the examples of the sensing layer 10 are not restricted.

Please refer to the step S3 and the step S4. As mentioned above, the first conductive particle layer 11 is uniformly distributed and adhesively fixed on the sensing layer 10. When the third adhesive layer 21 and the second adhesive layer 13 are adhered by each other, the second conductive particle layer 20 is uniformly and adhesively fixed over the first conductive particle layer 11. Consequently, if the third adhesive layer 21 and the second adhesive layer 13 are completely adhered by each other, the number of conductive particles over the first sensing unit 100 and the number of conductive particles over the second sensing unit 101 are identical because the size of the first sensing unit 100 and the size of the second sensing unit 101 are equal. Under this circumstance, the resistance values of the first sensing unit 100 and the second sensing unit 101 of the sensing layer 10 are substantially equal.

After the first resistance value of the first sensing unit 100 and the second resistance value of the second sensing unit 101 are detected, the bonding state of the first substrate 3 and the second substrate 4 is judged according to the result of comparing the first resistance value with the second resistance value. That is, if the first resistance value and the second resistance value are equal, it is considered that the second adhesive layer 13 of the first adhesive element 1 and the third adhesive layer 21 of the second adhesive element 2 are completely adhered by each other.

Moreover, when the first sensing unit 100 is electrically connected with a detecting device 5 (e.g., a multimeter) through the first sensing contact 103 and the second sensing contact 104, the first resistance value of the first sensing unit 100 is measured. Similarly, when the second sensing unit 101 is electrically connected with the same detecting device 5 through the third sensing contact 106 and the fourth sensing contact 107, the second resistance value of the second sensing unit 101 is measured.

From the above descriptions, the present invention provides a bonding state detection method. After the third adhesive layer 21 and the second adhesive layer 13 are adhered by each other, the second conductive particle layer 20 is adhesively fixed over the sensing layer 10. After the resistance values of the first sensing unit 100 and the second sensing unit 101 of the sensing layer 10 are detected, the bonding state of the first substrate 3 and the second substrate 4 is judged according to the result of comparing the first resistance value with the second resistance value. That is, if the first resistance value and the second resistance value are equal, it is considered that the second adhesive layer 13 of the first adhesive element 1 and the third adhesive layer 21 of the second adhesive element 2 are completely adhered by each other. Consequently, the bonding state detection method of the present invention is capable of detecting the bonding state of two substrates while overcoming the drawbacks of the conventional technology and achieving the unexpected efficacy.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A bonding state detection method, comprising steps of:
providing a first adhesive element, a second adhesive element, a first substrate and a second substrate, wherein the first adhesive element comprises a first conductive particle layer and a sensing layer, the sensing layer comprises a first sensing unit and a second sensing unit, and the second adhesive element comprises a second conductive particle layer;
allowing the first substrate and the second substrate to be bonded together through the first adhesive element and the second adhesive element, wherein the first adhesive element and the second adhesive element are arranged between the first substrate and the second substrate, the first conductive particle layer is adhesively fixed on the sensing layer, and the second conductive particle layer is adhesively fixed over the first conductive particle layer;
detecting a first resistance value of the first sensing unit and a second resistance value of the second sensing unit; and
comparing the first resistance value with the second resistance value, wherein if the first resistance value and the second resistance value are different, judging that the first adhesive element and the second adhesive element are not completely adhered by each other.

2. The bonding state detection method according to claim 1, wherein the first adhesive element further comprises a first adhesive layer and a second adhesive layer, wherein the second adhesive layer is located over the first adhesive layer, the sensing layer and the first conductive particle layer are arranged between the first adhesive layer and the second adhesive layer, the first substrate is adhered by the first adhesive layer, and the second adhesive element and the second adhesive layer are adhered by each other.

3. The bonding state detection method according to claim 2, wherein the second adhesive element further comprises a third adhesive layer and a fourth adhesive layer, wherein the fourth adhesive layer is located over the third adhesive layer, the second conductive particle layer is arranged between the third adhesive layer and the fourth adhesive layer, the third adhesive layer and the second adhesive layer are adhered by each other, and the second substrate is adhered by the fourth adhesive layer.

4. The bonding state detection method according to claim 3, wherein when the third adhesive layer and the second adhesive layer are adhered by each other, the second conductive particle layer is adhesively fixed over the first conductive particle layer.

5. The bonding state detection method according to claim 1, wherein the first sensing unit comprises a first conduction structure, and the second sensing unit comprises a second conduction structure, wherein the first conduction structure is electrically connected with a first sensing contact and a second sensing contact, and connected with a detecting device through the first sensing contact and the second sensing contact, wherein the second conduction structure is electrically connected with a third sensing contact and a fourth sensing contact, and connected with the detecting device through the third sensing contact and the fourth sensing contact.

6. The bonding state detection method according to claim 1, wherein the first sensing unit comprises plural first conduction structures, which are electrically connected with each other, wherein the second sensing unit comprises plural second conduction structures, which are electrically connected with each other, wherein the two first conduction structures at locations near two opposite sides of the first adhesive element are electrically connected with a first sensing contact and a second sensing contact, and connected with a detecting device through the first sensing contact and the second sensing contact, wherein the two second conduction structures at locations near the two opposite sides of the first adhesive element are electrically connected with a third sensing contact and a fourth sensing contact, and connected with the detecting device through the third sensing contact and the fourth sensing contact.

7. The bonding state detection method according to claim 1, wherein a size of the first sensing unit and a size of the second sensing unit are equal.

8. The bonding state detection method according to claim 1, wherein the first sensing unit and the second sensing unit are in parallel with each other.
